(19) United States
(12) Patent Application Publication
(10) Pub. No.: US 2020/0319515 A1
(43) Pub. Date: Oct. 8, 2020

(54) DISPLAY DEVICE

(71) Applicant: Wuhan China Star Optoelectronics Technology Co., Ltd., Wuhan (CN)

(72) Inventor: Yichi ZHANG, Wuhan (CN)

(73) Assignee: Wuhan China Star Optoelectronics Technology Co., Ltd., Wuhan (CN)

(21) Appl. No.: 16/464,689

(22) PCT Filed: Mar. 6, 2019
(86) PCT No.: PCT/CN2019/077083

§ 371 Date: May 29, 2019

(30) Foreign Application Priority Data
Nov. 29, 2018 (CN) 201811447861.9

(51) Int. Cl. G02F 1/13357; G02F 1/1368; G02F 1/1335; G02F 1/1343

(52) U.S. Cl. CPC G02F 1/133617; G02F 1/1368; G02F 1/13394; G02F 1/134309; G02F 1/133553

(57) ABSTRACT

A display device is provided. The display device improves utilization efficiency of ambient light and NTSC color gamut by disposing a reflective layer on one side of a thin film transistor array substrate away from a first substrate and a fluorescent layer between the first substrate and the thin film transistor array substrate, so that display performance is improved.

### BACKGROUND OF INVENTION

### Field of Invention

The present invention relates to a technical filed of display, and more particularly, to a display device.

### Description of Prior Art

Currently, liquid crystal displays are mainly classified into transmissive liquid crystal displays, reflective liquid crystal displays, and transflective liquid crystal displays. Among them, reflective liquid crystal displays have advantages of utilizing an external light source and relatively low power consumption, and reflective liquid crystal displays can be used in outdoor displays and wearable devices.

General reflective liquid crystal displays include a reflective layer, an array substrate, a liquid crystal layer, a color film, and a polarizer disposed in sequence. After ambient light is incident on a display surface of the liquid crystal display, it passes through the polarizer, the color film, the liquid crystal layer, and the array substrate, and then reaches the reflective layer. After the ambient light is reflected by the reflective layer, reflected light passes through the array substrate, the liquid crystal layer, the color film, and the polarizer. Then, the display surface of the reflective liquid crystal display emits the ambient light. A typical reflective liquid crystal display has low utilization efficiency of the ambient light, and thus brightness of the liquid crystal display is insufficient. Traditionally, enlarging a pixel size and reducing a thickness of the color film can increase the ambient light reflectivity. However, enlarging the pixel size can increase graininess of images, and thus the thickness of the color film and the color gamut are reduced. Therefore, display performance of the reflective liquid crystal is affected.

### SUMMARY OF INVENTION

In view of the deficiencies of the prior art, a display device is provided. The display device has high utilization efficiency of the ambient light and can improve color gamut. Therefore, the display device has a good display performance.

According to one embodiment, a display device comprises:

a thin film transistor array substrate;

a first substrate disposed opposite to the thin film transistor array substrate;

a fluorescent layer, and the fluorescent layer is disposed between the thin film transistor array substrate and the first substrate, and the fluorescent layer is used for absorbing ultraviolet light to generate visible light; and

a reflective layer disposed at one side of the thin film transistor array substrate away from the first substrate; and the fluorescent layer is an organic fluorescent layer.

In one embodiment, the display device further comprises a liquid crystal layer, and the fluorescent layer is disposed between the liquid layer and the first substrate.

In one embodiment, the display device further comprises a liquid crystal layer, and the fluorescent layer is disposed between the liquid layer and the thin film transistor array substrate.

In one embodiment, the organic fluorescent layer comprises a red fluorescent unit, a green fluorescent unit, and a blue fluorescent unit.

In one embodiment, a common electrode is disposed on a surface of the first substrate opposite to the thin film transistor array substrate.

In one embodiment, the fluorescent layer is disposed on the first substrate, and the common electrode is disposed between the fluorescent layer and the first substrate.

In one embodiment, the fluorescent layer is disposed on the first substrate, and the fluorescent layer is disposed between the common electrode and the first substrate.

In one embodiment, the substrate is a transparent substrate.

In one embodiment, the reflective layer is a metal layer.

According to one embodiment, a display device comprises:

a thin film transistor array substrate;

a first substrate disposed opposite to the thin film transistor array substrate;

a fluorescent layer, and the fluorescent layer is disposed between the thin film transistor array substrate and the first substrate, and the fluorescent layer is used for absorbing ultraviolet light to generate visible light; and

a reflective layer disposed at one side of the thin film transistor array substrate away from the first substrate.

In one embodiment, the display device further comprises a liquid crystal layer, and the fluorescent layer is disposed between the liquid layer and the first substrate.

In one embodiment, the display device further comprises a liquid crystal layer, and the fluorescent layer is disposed between the liquid layer and the thin film transistor array substrate.

In one embodiment, a common electrode is disposed on a surface of the first substrate opposite to the thin film transistor array substrate.

In one embodiment, the fluorescent layer is disposed on the first substrate, and the common electrode is disposed between the fluorescent layer and the first substrate.

In one embodiment, the fluorescent layer is disposed on the first substrate, and the fluorescent layer is disposed between the common electrode and the first substrate.

In one embodiment, the substrate is a transparent substrate.

In one embodiment, the reflective layer is a metal layer.

In one embodiment, the metal layer consists of any one of silver or aluminum.

In one embodiment, the reflective layer is a combining layer consisted of a metal layer and an indium tin oxide layer.

A display device is provided by one embodiment of the present application. The display device improves a utilization efficiency of ambient light and NTSC color gamut by disposing a reflective layer on one side of the thin film transistor array substrate away from the first substrate and a fluorescent layer between the first substrate and the thin film transistor array substrate, so that display performance is improved.

### BRIEF DESCRIPTION OF DRAWINGS

FIG. 1 is a reflectance map showing a common organic red pigment 1 and a red organic fluorescent material 2 that reflect different light wavelengths by irradiating the same ambient light under the same conditions.

FIG. 2 is a schematic view of a display device according to a first embodiment of the present application.

FIG. 3 is a National Television Standards Committee (NTSC) color gamut comparative diagram between the display device shown in FIG. 2 and an existing product.

FIG. 4 is a schematic view of a display device according to a second embodiment of the present application.

FIG. 5 is a schematic view of a display device according to a third embodiment of the present application.

### DETAILED DESCRIPTION OF PREFERRED EMBODIMENTS

The technical solutions in the embodiments of the present application will be clearly and completely described in the following with reference to the accompanying drawings in the embodiments. Apparently, the described embodiments are only a part of the embodiments of the present application, and not all of them. All other embodiments obtained by a person skilled in the art based on the embodiments of the present application without creative efforts are within the scope of the present application.

According to one embodiment of the present application, a display device is provided. The display device includes a thin film transistor array substrate; a first substrate disposed opposite to the thin film transistor array substrate; a fluorescent layer, the fluorescent layer is disposed between the thin film transistor array substrate and the first substrate, and the fluorescent layer is used for absorbing ultraviolet light to generate visible light; and a reflective layer disposed at one side of the thin film transistor array substrate away from the first substrate.

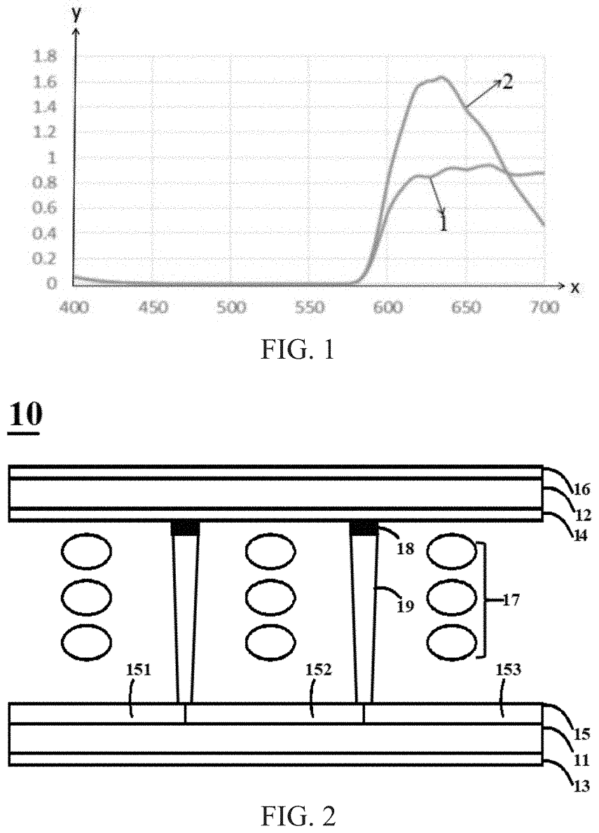

FIG. 1 is a reflectance map showing a common organic red pigment 1 (Chinese name: Pigment Red 177, CAS number: 4051-63-2) and a red organic fluorescent material 2 (Chinese name: alkaline red 1, CAS number:989-38-8) that reflect different light wavelengths by irradiating the same ambient light (the X-axis is the wavelength, and the Y-axis is the reflectance) under the same conditions. The ambient light is reflected by the red organic fluorescent material 2 and the reflectance of the red visible light having a wavelength of 620-670 nm is between 1 and 1.8. A reflection curve of the red organic fluorescent material 2 has a distinct maximum reflectance peak. Therefore, the red organic fluorescent material 2 is used as a color film is advantageous for improving color purity. When ambient light is reflected by the common organic red pigment 1, red visible light emitted from the ambient light having different wavelengths has a reflectance of less than 1. Utilization efficiency of the ambient light by the red organic fluorescent material 2 is higher than that of the common red organic pigment 1. The main reason for the different utilization efficiency between the common organic red pigment 1 and the red organic fluorescent material 2 is that the red organic fluorescent material 2 is excited by ultraviolet light emitted from the ambient light to generate part of red visible light and the common organic red pigment 1 is irradiated by the ambient light to emit red light by absorbing light excluded from red light.

The above-mentioned display device is a reflective display, and a light source of the display device is ambient light. A reflective layer is disposed at one side of the thin film transistor array substrate away from the first substrate to reflect the ambient light from the reflective layer to the fluorescent layer. The ultraviolet light emitted from the ambient light passes through the fluorescent layer to excite the fluorescent material to generate visible light. The common organic pigment is used for color filters of conventional liquid crystal devices. When the ambient light passes through the color filter, only corresponding color visible light can pass through the color filter and other color visible light is absorbed by the color filter. Compared with the conventional reflective liquid crystal display, the utilization efficiency of the ambient light can be improved by the display device of the present application.

Referring to FIG. 2, it is a schematic view of display device 10 according to a first embodiment of the present application. The display device 10 includes:
a thin film transistor array substrate 11;
a first substrate 12 disposed opposite to the thin film transistor array substrate 11;
a fluorescent layer 15; the fluorescent layer 15 is disposed between the thin film transistor array substrate 11 and the first substrate 12, and the fluorescent layer 15 is used for absorbing ultraviolet light to generate visible light;
a reflective layer 13 disposed at one side of the thin film transistor array substrate 11 away from the first substrate 12;
a common electrode 14; the common electrode 14 is disposed on a surface of the first substrate 12 opposite to the thin film transistor array substrate 11;
a polarizing layer 16; the polarizing layer 16 is disposed on the surface of the first substrate 12 away from the thin film transistor array substrate 11;
a liquid crystal layer 17; the liquid crystal layer 17 is disposed between the common electrode 14 and fluorescent layer 15;
a black matrix 18; the black matrix 18 is disposed on the common electrode 14 in an array arrangement; and
a spacer 19; the spacer 19 is disposed between the common electrode 14 and fluorescent layer 15.

In one embodiment, the thin film transistor array substrate 11 is consisted of a substrate and a thin film transistor array disposed on the substrate, and the thin film transistor functions as a switching element to control the rotation of the liquid crystal in the liquid crystal layer 17, thereby controlling a display state of the display device 10.

In one embodiment, the first substrate 12 is transparent substrate such as a glass substrate, and the glass substrate has a thickness of 0.3-0.7 mm.

In one embodiment, a function of the reflective layer 13 is to reflect the light incident from the reflective layer 13 to the fluorescent layer 15. The reflective layer 13 is disposed outside the thin film transistor array substrate 11 to ensure that ambient light incident from the display device can be reflected to the fluorescent layer, so that a utilization efficiency of the ambient light is improved. The reflective layer 13 is a metal layer, and the metal layer is prepared by one of silver or aluminum. In another embodiment, the reflective layer 13 may also be a combining layer consisted a metal layer and an indium tin oxide (ITO) layer.

In one embodiment, the common electrode 14 is disposed on a surface of the first substrate 12 opposite to the thin film transistor array substrate 11. The common electrode 14 forms a vertical electric field with the pixel electrode disposed on the thin film transistor array substrate 11 to control the deflection of the liquid crystal layer 17, and thus the display state of the display device 10 is controlled. The common electrode 14 is prepared by ITO and has a thickness of 0.1 μm to 0.16 μm.

In one embodiment, the fluorescent layer 15 is used to increase the utilization efficiency of the ambient light by the display device 10. The fluorescent layer 15 is disposed on the thin film transistor array substrate 11, and the fluorescent layer 15 is also disposed between the liquid crystal layer 17 and the thin film transistor array substrate 11. The fluorescent layer 15 is an organic fluorescent layer. In another embodiment, the fluorescent layer 15 may also be an inorganic fluorescent layer. When the fluorescent layer 15 is the organic fluorescent layer, the organic fluorescent layer 15 includes a red fluorescent unit 151, a green fluorescent unit 152, and a blue fluorescent unit 153. The red fluorescent unit 151, a green fluorescent unit 152, and a blue fluorescent unit 153 included in the organic fluorescent layer 15 are repeatedly disposed on the thin film transistor array substrate 11 in sequence. The red fluorescent unit 151 is prepared by an organic red fluorescent material such as Rhodamine B (CAS No.: 81-88-9) and Basic Red 1 (CAS No.: 989-38-8). The blue fluorescent unit 153 is prepared by an organic blue fluorescent material such as 7-(diethylamino) coumarin (CAS No.: 20571-42-0) and a reduced methylene blue (CAS No.: 613-11-6). The green fluorescent unit 152 is prepared by an organic green fluorescent material such as Lumogen Bright Green (CAS No.: 47375-13-3) and Solvent Green 7 (CAS No.: 6358-69-6).

The polarizing layer 16 has a function to change a light passing through the polarizing layer 16 into a polarized light. In one embodiment, the polarizing layer 16 is a transmissive polarizer layer.

The black matrix 18 is disposed above the thin film transistor of the thin film transistor array substrate 11 to prevent light from being irradiated onto the active layer of the thin film transistor to generate electric leakage. The black matrix 18 is prepared by, but is not limited to, a mixture of ferrous metals (e.g., chrome), acrylates, and black pigments, and the black matrix 18 has a thickness of from 1 μm to 1.5 μm.

The spacer 19 is a column shape, and it has a function to control a thickness of the liquid crystal layer 17. The spacer 19 is prepared by, but is not limited to, polymethyl methacrylate. A height of the spacer 19 is from 3 μm to 4 μm.

In one embodiment, when the ambient light irradiates the display device 10, the ambient light sequentially passes through the polarizing layer 16, the first substrate 12, the common electrode 14, the liquid crystal layer 17, the fluorescent layer 15, and the thin film transistor array substrate 11 to reach the reflective layer 13, and the ambient light is reflected by the reflective layer 13 to reach the fluorescent layer 15. When the ambient light passes through the fluorescent layer 15, an ultraviolet light emitted from the ambient light excites the fluorescent material of the fluorescent layer to generate visible light. Specifically, the ultraviolet light passing through the red fluorescent unit 151 induces the organic red fluorescent material to be excited to generate red visible light. The ultraviolet light passing through the green fluorescent unit 152 induces the organic green fluorescent material to be excited to generate green visible light. The ultraviolet light passing through the blue fluorescent unit 153 induces the organic blue fluorescent material is excited to generate blue visible light. At the same time, visible light emitted from the ambient light transmits red visible light when the visible light passes through the red fluorescent unit 151. The visible light emitted from the ambient light respectively transmits green visible light and blue visible light when the visible light passes through the green fluorescent unit 152 and the blue fluorescent unit 153. Therefore, the visible light emitted from the fluorescent layer 15 includes visible light generated by the ultraviolet light emitted from the ambient light and visible light emitted from the ambient light which is transmitted to the fluorescent layer 15. The visible light emitted from the fluorescent layer 15 sequentially passes through the liquid crystal layer 17, the common electrode 14, the first substrate 12, and the polarizing layer 16. It can be understood that the display device of the embodiment can improve the utilization efficiency of the ambient light, so that the display performance is improved.

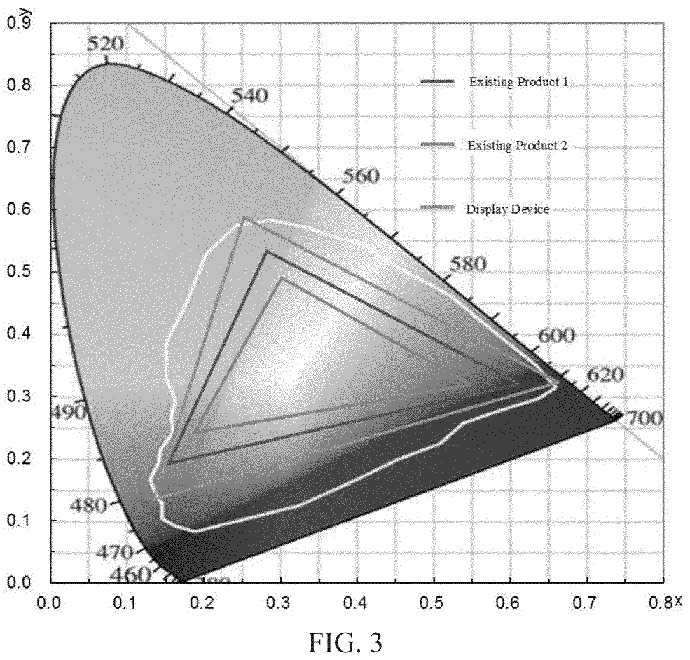

FIG. 3 is a National Television Standards Committee (NTSC) color gamut comparative diagram for the display device (the design of the present application shown in FIG. 3), the existing product 1 and the existing product 2 under the same conditions. Color filters used for the existing product 1 and the existing product 2 are made of common organic pigments. The difference is that a thickness of the color filter of the existing product 1 is greater than a thickness of the color filter of the existing product 2. The display device of the embodiment uses an organic fluorescent material to form a fluorescent layer, and the existing product 1 uses the common organic pigments to form a color filter. The X-axis and the Y-axis of the NTSC gamut are tristimulus values, and the color gamut consists of a straight line and a curve, and the wavelength of light wave is marked on the curve, and the unit is nm. In FIG. 3, the NTSC of the display device of the embodiment has a largest color gamut area, and the NTSC color gamut is 60-80%. The existing product 1 and the existing product 2 have the NTSC color gamut of 20-40%, and the color gamut of the product 1 is larger than the color gamut of the existing product 2. Therefore, the display device of the embodiment can improve the color gamut and display performance. Compared with the existing product 1, the existing product, and the display device, the display device of the embodiment can improve the color gamut is that the display device of the embodiment uses a fluorescent layer to ensure that the utilization efficiency of the ambient light is improved. Accordingly, a thickness of the fluorescent layer can be increased, and thus color saturation and NTSC color gamut are increased. The thickness of the color filter made of common organic pigments is thicker, which is not beneficial to the use of ambient light by the display device.

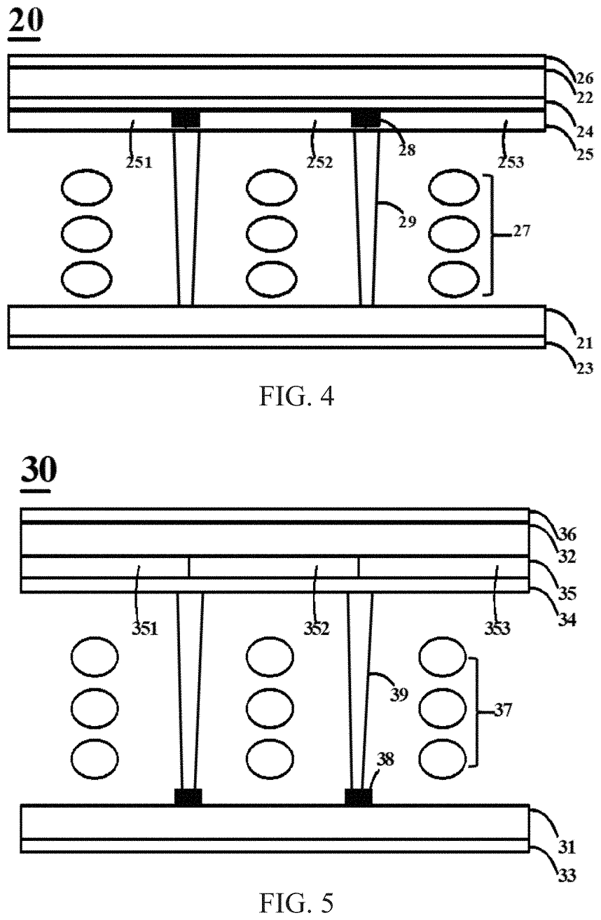

Referring to FIG. 4, it is a schematic view of display device 20 according to a second embodiment of the present application. The display device 20 includes:
a thin film transistor array substrate 21;
a first substrate 22 disposed opposite to the thin film transistor array substrate 21;
a fluorescent layer 25; the fluorescent layer 25 is disposed between the thin film transistor array substrate 21 and the first substrate 22, and the fluorescent layer 25 is used for absorbing ultraviolet light to generate visible light;
a reflective layer 23 disposed at one side of the thin film transistor array substrate 21 away from the first substrate 22;
a common electrode 24; the common electrode 24 is disposed on a surface of the first substrate 22 opposite to the thin film transistor array substrate 21;
a polarizing layer 26; the polarizing layer 26 is disposed on the surface of the first substrate 22 away from the thin film transistor array substrate 21;
a liquid crystal layer 27; the liquid crystal layer 27 is disposed between the thin film transistor array substrate 21 and the fluorescent layer 25;
a black matrix 28; the black matrix 28 is disposed on the common electrode 24 in an array arrangement; and
a spacer 29; the spacer 29 is disposed between the thin film transistor array substrate 21 and the fluorescent layer 25.

In one embodiment, the fluorescent layer 25 is disposed on the first substrate 22, and the common electrode 24 is disposed between the fluorescent layer 25 and the first substrate 22. The fluorescent layer 25 is an organic fluorescent layer. A red fluorescent unit 251, a green fluorescent unit 252, and a blue fluorescent unit 253 included in the organic fluorescent layer are repeatedly disposed on the common electrode 24 of the first substrate 22 in sequence. A black matrix 29 is disposed between adjacent fluorescent units. Compared with the first embodiment, the fluorescent layer 25 disposed on the first substrate 22 can improve the reflection of ambient light on a surface of the fluorescent layer 25 and reduce contrast when the display device displays an image.

Referring to FIG. 5, it is a schematic view of a display device 30 according to a third embodiment of the present application. The display device 30 includes:
a thin film transistor array substrate 31;
a first substrate 32 disposed opposite to the thin film transistor array substrate 31;
a fluorescent layer 35; the fluorescent layer 35 is disposed between the thin film transistor array substrate 31 and the first substrate 32, and the fluorescent layer 35 is used for absorbing ultraviolet light to generate visible light;
a reflective layer 33 disposed at one side of the thin film transistor array substrate 31 away from the first substrate 32;
a common electrode 34; the common electrode 34 is disposed on a surface where the first substrate 32 is opposite to the thin film transistor array substrate 31, and the fluorescent layer 35 is disposed between the common electrode 34 and the first substrate 32;
a polarizing layer 36; the polarizing layer 36 is disposed on a surface of the first substrate 32 away from the thin film transistor array substrate 31;
a liquid crystal layer 37; the liquid crystal layer 37 is disposed between the common electrode 34 and the thin film transistor array substrate 31;
a black matrix 38; the black matrix 38 is disposed on a surface of the thin film transistor array substrate 31 opposite to the first substrate 32 in an array arrangement;
and a spacer 39, the spacer 39 is disposed between the common electrode 34 and the thin film transistor array substrate 31.

The third embodiment is substantially similar to the second embodiment, and the difference is that the fluorescent layer 35 is disposed on the surface of the first substrate 32 opposite to the thin film transistor array substrate 31, and the fluorescent layer 35 is disposed between the common electrode 34 and the first substrates 32. The fluorescent layer 35 is an organic fluorescent layer, and a red fluorescent unit 351, a green fluorescent unit 352, and a blue fluorescent unit 353 included in the organic fluorescent layer are repeatedly disposed on the first substrate 32 in sequence. In addition, the black matrix 38 is disposed on the thin film transistor array substrate 31. In the second embodiment, the black matrix 28 is disposed on the common electrode 24 of the first substrate 22. Compared with the second embodiment, the third embodiment is advantageous for simplifying the manufacturing process of the display device 30.

In the above, the present application has been described in the above preferred embodiments, but the preferred embodiments are not intended to limit the scope of the invention, and a person skilled in the art may make various modifications without departing from the spirit and scope of the application. The scope of the present application is determined by claims.

What is claimed is:

1. A display device, comprising:
a thin film transistor array substrate;
a first substrate disposed opposite to the thin film transistor array substrate;
a fluorescent layer, wherein the fluorescent layer is disposed between the thin film transistor array substrate and the first substrate, and the fluorescent layer is used for absorbing ultraviolet light to generate visible light; and
a reflective layer disposed at one side of the thin film transistor array substrate away from the first substrate;
wherein the fluorescent layer is an organic fluorescent layer.

2. The display device according to claim 1, wherein the display device further comprises a liquid crystal layer, and the fluorescent layer is disposed between the liquid layer and the first substrate.

3. The display device according to claim 1, wherein the display device further comprises a liquid crystal layer, and the fluorescent layer is disposed between the liquid layer and the thin film transistor array substrate.

4. The display device according to claim 1, wherein the organic fluorescent layer comprises a red fluorescent unit, a green fluorescent unit, and a blue fluorescent unit.

5. The display device according to claim 1, wherein a common electrode is disposed on a surface of the first substrate opposite to the thin film transistor array substrate.

6. The display device according to claim 5, wherein the fluorescent layer is disposed on the first substrate, and the common electrode is disposed between the fluorescent layer and the first substrate.

7. The display device according to claim 5, wherein the fluorescent layer is disposed on the first substrate, and the fluorescent layer is disposed between the common electrode and the first substrate.

8. The display device according to claim 1, wherein the substrate is a transparent substrate.

9. The display device according to claim 1, wherein the reflective layer is a metal layer.

10. The display device according to claim 9, wherein the metal layer consists of any one of silver or aluminum.

11. A display device, comprising:
a thin film transistor array substrate;
a first substrate disposed opposite to the thin film transistor array substrate;
a fluorescent layer, wherein the fluorescent layer is disposed between the thin film transistor array substrate and the first substrate, and the fluorescent layer is used for absorbing ultraviolet light to generate visible light; and
a reflective layer disposed at one side of the thin film transistor array substrate away from the first substrate.

12. The display device according to claim 11, wherein the display device further comprises a liquid crystal layer, and the fluorescent layer is disposed between the liquid layer and the first substrate.

13. The display device according to claim 11, wherein the display device further comprises a liquid crystal layer, and the fluorescent layer is disposed between the liquid layer and the thin film transistor array substrate.

14. The display device according to claim 11, wherein a common electrode is disposed on a surface of the first substrate opposite to the thin film transistor array substrate.

15. The display device according to claim 14, wherein the fluorescent layer is disposed on the first substrate, and the common electrode is disposed between the fluorescent layer and the first substrate.

16. The display device according to claim 14, wherein the fluorescent layer is disposed on the first substrate, and the fluorescent layer is disposed between the common electrode and the first substrate.

17. The display device according to claim 11, wherein the substrate is a transparent substrate.

18. The display device according to claim 11, wherein the reflective layer is a metal layer.

19. The display device according to claim 18, wherein the metal layer consists of any one of silver or aluminum.

20. The display device according to claim 18, wherein the reflective layer is a combining layer consisted of a metal layer and an indium tin oxide layer.
